(19) United States
(12) Patent Application Publication
(10) Pub. No.: US 2026/0217281 A1
(43) Pub. Date: Jul. 30, 2026

(54) DEGRADED DRIVING FOR AUTONOMOUS VEHICLES THROUGH VEHICLE-TO-VEHICLE (V2V) COMMUNICATION AND AUTONOMOUS VEHICLE-TO-AUTONOMOUS VEHICLE (AV2AV) PAIRING

(71) Applicant: Torc Robotics, Inc., Blacksburg, VA (US)

(72) Inventors: Rasika Kangutkar, Austin, TX (US); Mehdi Zamanipour, Mclean, VA (US)

(21) Appl. No.: 19/037,011

(22) Filed: Jan. 24, 2025

(51) Int. Cl. B60W 60/00; B60W 50/029

(52) U.S. Cl. CPC B60W 60/00186; B60W 50/029; B60W 2556/65

(57) ABSTRACT

An autonomous vehicle including at least one memory configured to store machine executable instructions, and at least one processor coupled to the at least one memory is disclosed. The at least one processor is configured to execute the machine executable instructions to: (i) receive information indicating a second autonomous vehicle is in a degraded mode using a vehicle-to-vehicle (V2V) or vehicle-to-everything (V2X) communication technique; (ii) pair with the second autonomous vehicle using an autonomous vehicle-to-autonomous vehicle (AV2AV) communication technique; (iii) transmit data to the second autonomous vehicle using the AV2AV communication technique; and (iv) assist the second autonomous vehicle to perform a minimal risk maneuver using the transmitted data.

### TECHNICAL FIELD

The field of the disclosure relates generally to safe operations of an autonomous vehicle and, more specifically, improving degraded driving for, or performing a minimal risk maneuver (MRM) by, an autonomous vehicle using vehicle-to-vehicle (V2V) communication and autonomous vehicle-to-autonomous vehicle (AV2AV) pairing.

### BACKGROUND OF THE INVENTION

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

Perception technologies and localization technologies are based upon sensor data of different types of sensors. Behaviors and planning technologies, and controller technologies are based upon a processor, for example. In the event of a failure in the processor or the sensors, an obstruction of a sensor, or other reasons, the autonomous vehicle may need to safely operate in a degraded driving operation or perform a minimal risk maneuver (MRM).

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, an autonomous vehicle including at least one memory configured to store machine executable instructions, and at least one processor coupled to the at least one memory is disclosed. The at least one processor is configured to execute the machine executable instructions to: (i) determine a failure corresponding to a sensor requiring the autonomous vehicle to enter into a degraded mode; (ii) communicate information with another vehicle or a base station using a vehicle-to-vehicle (V2V) or vehicle-to-everything (V2X) communication technique; (iii) based upon the other vehicle agreeing to assist the autonomous vehicle in the degraded mode, pair with the other vehicle using an autonomous vehicle-to-autonomous vehicle (AV2AV) communication technique; (iv) receive data from the other vehicle using the AV2AV communication technique; and (v) perform a minimal risk maneuver using the received data.

In another aspect, a computer-implemented method is disclosed. The computer-implemented method includes (i) determining a failure corresponding to a sensor requiring an autonomous vehicle to enter into a degraded mode; (ii) communicating information with another vehicle or a base station using a vehicle-to-vehicle (V2V) or vehicle-to-everything (V2X) communication technique; (iii) based upon the other vehicle agreeing to assist the autonomous vehicle in the degraded mode, pairing with the other vehicle using an autonomous vehicle-to-autonomous vehicle (AV2AV) communication technique; (iv) receiving data from the other vehicle using the AV2AV communication technique; and (v) performing a minimal risk maneuver using the received data.

In yet another aspect, a non-transitory computer-readable media (CRM) including machine executable instructions stored thereon is disclosed. The machine executable instructions, when executed by at least one processor of a computing system of an autonomous vehicle, cause the computing system to perform operations including: (i) determining a failure corresponding to a sensor requiring the autonomous vehicle to enter into a degraded mode; (ii) communicating information with another vehicle or a base station using a vehicle-to-vehicle (V2V) or vehicle-to-everything (V2X) communication technique; (iii) based upon the other vehicle agreeing to assist the autonomous vehicle in the degraded mode, pairing with the other vehicle using an autonomous vehicle-to-autonomous vehicle (AV2AV) communication technique; (iv) receiving data from the other vehicle using the AV2AV communication technique; and (v) performing a minimal risk maneuver using the received data.

In yet another aspect, an autonomous vehicle including at least one memory configured to store machine executable instructions, and at least one processor coupled to the at least one memory is disclosed. The at least one processor is configured to execute the machine executable instructions to: (i) receive information indicating a second autonomous vehicle is in a degraded mode using a vehicle-to-vehicle (V2V) or vehicle-to-everything (V2X) communication technique; (ii) pair with the second autonomous vehicle using an autonomous vehicle-to-autonomous vehicle (AV2AV) communication technique; (iii) transmit data to the second autonomous vehicle using the AV2AV communication technique; and (iv) assist the second autonomous vehicle to perform a minimal risk maneuver using the transmitted data.

In yet another aspect, a computer-implemented method is disclosed. The computer-implemented method includes (i) receiving, by a processor of a first autonomous vehicle, information indicating a second autonomous vehicle is in a degraded mode using a vehicle-to-vehicle (V2V) or vehicle-to-everything (V2X) communication technique; (ii) pairing, by the processor, with the second autonomous vehicle using an autonomous vehicle-to-autonomous vehicle (AV2AV) communication technique; (iii) transmitting, by the processor, data to the second autonomous vehicle using the AV2AV communication technique; and (iv) assisting, by the processor, the second autonomous vehicle to perform a minimal risk maneuver using the transmitted data.

In yet another aspect, a non-transitory computer-readable media (CRM) including machine executable instructions stored thereon is disclosed. The machine executable instructions, when executed by at least one processor of a computing system of an autonomous vehicle, cause the computing system to perform operations including: (i) receiving information indicating a second autonomous vehicle is in a degraded mode using a vehicle-to-vehicle (V2V) or vehicle-to-everything (V2X) communication technique; (ii) pairing with the second autonomous vehicle using an autonomous vehicle-to-autonomous vehicle (AV2AV) communication technique; (iii) transmitting data to the second autonomous vehicle using the AV2AV communication technique; and (iv) assisting the second autonomous vehicle to perform a minimal risk maneuver using the transmitted data.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The patent or application file contains at least one drawing executed in color. Copies of this patent or patent application publication with color drawing(s) will be provided by the Office upon request and payment of the necessary fee.

The following drawings form part of the present specification and are included to further demonstrate certain aspects of the present disclosure. The disclosure may be better understood by reference to one or more of these drawings in combination with the detailed description of specific embodiments presented herein.

FIG. 1. is a schematic view of an autonomous truck;

FIG. 2 is a block diagram of the autonomous truck shown in FIG. 1;

FIG. 3 is a block diagram of an example computing system;

FIG. 4 is an example illustration of a setup of a degraded autonomous vehicle for safe operating in a degraded driving mode or performing a minimal risk maneuver (MRM);

FIG. 5 is a flow diagram of an embodiment method of safe operating in a degraded driving mode or performing a minimal risk maneuver (MRM); and

FIG. 6 is a flow diagram of an embodiment method of assisting an autonomous vehicle in a degraded driving mode to perform a minimal risk maneuver (MRM).

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

Some structural or method features may be shown in specific arrangements and/or orderings in the drawings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments, and, in some embodiments, it may not be included or may be combined with other features.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

One or more of the following terms may be used in the disclosure, and their definition is provided below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

Mission control: Mission control, as described in the present disclosure, refers to one or more application servers, and one or more database servers communicatively coupled with each other and one or more autonomous vehicles of a fleet. Mission control receives sensor data collected by one or more sensors of the one or more autonomous vehicles of the fleet and transmit data including, but not limited to, trajectory data, described herein, to the one or more autonomous vehicles of the fleet.

Vehicle-to-Vehicle (V2V) communication: V2V communication, as described herein, refers to a technology allowing vehicles to communicate with each other, for example, for sharing information, data, etc., using wireless communication protocols. Wireless communication protocols used for V2V communications may include, for example, short-range radio communication (DSRC). Information or data shared using V2V communication may include, but is not limited only to, a vehicle speed, heading, braking status, etc.

Vehicle-to-everything (V2X) communication: Vehicle-to-everything (V2X) communication, as described herein, refers to a technology allowing vehicles to communicate with other vehicles, infrastructure, other road users, etc., for sharing information, data, etc., using wireless communication protocols. Wireless communication protocols used for V2X communications may include, for example, short-range radio communication (DSRC), Wi-Fi, 4G, 5G, satellite communication network, Bluetooth, cellular technologies according to third generation partnership project (3GPP) standards, etc. Information or data shared using V2X communication may include, but is not limited only to, a vehicle speed, heading, braking status, traffic light status, road sign information, traffic information, etc.

Autonomous vehicle-to-autonomous vehicle (AV2AV) pairing: Autonomous vehicle-to-autonomous vehicle (AV2AV) pairing, as described herein, refers to two autonomous vehicles communicating with each other using V2V communication. Particularly, an autonomous vehicle that has entered into a degraded state (or degraded mode), or that is performing a minimal risk maneuver (MRM), and referenced herein as a degraded autonomous vehicle, is paired with another autonomous vehicle to receive information or data that increases safety of the degraded autonomous vehicle. The information of data shared among the two autonomous vehicles includes, but not limited to, sensor configurations, an autonomous vehicle diagnostic information, a failure state, a geographic location, one or more autonomous vehicle outputs, etc. The AV2AV pairing is implemented in such a way that an external entity cannot breach the AV2AV connection, and misuse of hijack the communication between two paired autonomous vehicles using AV2AV communication technique.

As described herein, perception technologies and localization technologies rely on sensor data of different types of sensors including perception sensors, localization sensors. Perception sensors include an imaging (or a camera) sensor, a light detection and ranging (LiDAR) sensor, and a radio detection and ranging (RADAR) sensor. Localization sensors include an accelerometer, a gyroscope, a magnetometer, and a compass. Failure in a perception or localization sensor, or obstruction of the perception sensor, or a failure in a processor used for perception or localization software may cause unavailability of the required perception or localization data for safe operation of an autonomous vehicle. Similarly, a fault in a processor used for behaviors and planning technologies and controller technologies may occur causing a safe operation of the autonomous vehicle. Unavailability of required perception or localization sensor data, or a fault in the processor, cause the autonomous vehicle to enter into a degraded state or perform an MRM. Whether to enter into the degraded state or perform an MRM depends on a specific fault that caused the autonomous vehicle to enter into the degraded state or perform an MRM. Various embodiments in the present disclosure describe how an autonomous vehicle safely operate in the degraded state or perform an MRM using vehicle-to-vehicle (V2V) communication or vehicle-to-everything (V2X) communication and using direct audio-visual speech to audio-visual speech translation (AV2AV) pairing.

Generally, during the degraded state, the autonomous vehicle may lower its speed and stay in a lane, for example, a lane with a slowest driving speed. The autonomous vehicle may perform basis lane keeping operation and/or adaptive cruise control (ACC) operation using a redundant sensor. The autonomous vehicle may drive up to a nearest hub or mission control, where the particular fault may be diagnosed and fixed. Additionally, or alternatively, the autonomous vehicle may perform an MRM in which the autonomous vehicle stops on route by either stopping in lane, or pulling over to a road shoulder, etc. After an MRM is performed, a human intervention is generally needed in some form, either remotely or on site to diagnose, fix, and restart the autonomous vehicle. Accordingly, when the autonomous vehicle enters a reduced mode due to its lack of required contextual information of the scene, performing either of these in an uncertain and/or complex environment increases the level of risk for the autonomous vehicle and surrounding traffic actors and infrastructure.

Various embodiments disclosed herein improve safety of an autonomous vehicle, while the autonomous vehicle has entered into the degraded state, or while the autonomous vehicle is performing an MRM, using V2V or V2X communication. Additionally, or alternatively, AV2AV pairing may also be performed to improve safety of a degraded autonomous vehicle. The degraded autonomous vehicle receives scene information using V2V or V2X communication from other vehicles in proximity of the degraded autonomous vehicle. Scene information may include perception sensor information, kinematics information, or localization information of other vehicles collected by sensors of the other vehicles.

In some embodiments, the degraded autonomous vehicle may be paired with another vehicle (for example, another autonomous vehicle) for receiving one or more of perception sensor information, kinematics information, localization information, trajectory information, object information and location of the objects, and road geometry, etc. In an example embodiment, depending on a specific fault such as, a particular sensor failure, an obstruction of a particular sensor, or a particular processor failure, the degraded autonomous vehicle may be paired with another autonomous vehicle to receive specific information.

For example, if an autonomous vehicle entered into a degraded state because of excessive dirt on a camera sensor, or a damage to a camera sensor, positioned in the front of the autonomous vehicle, the degraded autonomous vehicle may pair with another autonomous vehicle to receive imaging data from another autonomous vehicle along with location information for each imaging data, so that using the location information and the corresponding imaging data, and location information of the degraded autonomous vehicle using localization technologies, the degraded autonomous vehicle can safely operate in the degraded state or while performing an MRM. While the example described herein is based on imaging data of the camera sensor, the techniques described herein can be used for any type of perception sensor data such as LiDAR data, RADAR data, etc.

In an example embodiment, the degraded autonomous vehicle may be paired with another autonomous vehicle that is in the same fleet as the degraded autonomous vehicle. Additionally, or alternatively, the degraded autonomous vehicle may be paired with another autonomous vehicle that is travelling along the same route or have a common route until the next service hub, where the degraded autonomous vehicle can be repaired or fixed.

In an example embodiment, the degraded autonomous vehicle may be paired with another vehicle of the fleet by exchanging particular information via mission control or using V2V or V2X communication. The particular information may include an identification code of the degraded autonomous vehicle, a current location of the degraded autonomous vehicle, and a fault code. The fault code may identify what sensor or processor fault caused the autonomous vehicle to become the degraded autonomous vehicle. Since the paired autonomous vehicles are in the same fleet, the paired autonomous vehicle in a good condition can provide necessary information to the degraded autonomous vehicle for operating safely in the degraded state.

In an example embodiment, the degraded autonomous vehicle may be paired with another vehicle that is not in the same fleet as the degraded autonomous vehicle by exchanging particular information using V2V or V2X communication. The particular information may include an identification code of the degraded autonomous vehicle, a current location of the degraded autonomous vehicle, kinematic information of the degraded autonomous vehicle, route information, a fault code, and/or description of the fault. Other autonomous vehicles in a good condition can provide their current location information for the degraded autonomous vehicle to determine pairing with another autonomous vehicle in a good condition.

Upon pairing, the autonomous vehicle in a good condition may assist the degraded autonomous vehicle, for example, by driving ahead of the degraded autonomous vehicle like a virtual towing, changing its current route to be same as the route of the degraded autonomous vehicle, or by leading the degraded autonomous vehicle to the nearest service hub to get the degraded autonomous vehicle get fixed or repaired.

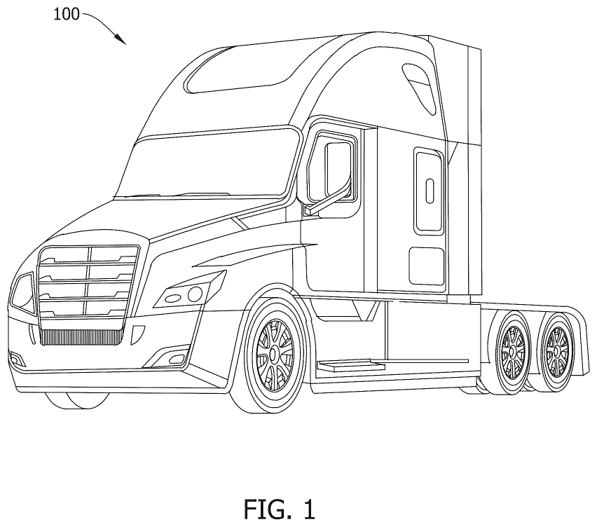

FIG. 1 illustrates a vehicle 100, such as a truck that may be conventionally connected to a single or tandem trailer to transport the trailer (not shown in FIG. 1) to a desired location. The vehicle 100 includes a cabin that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin.

The vehicle 100 may be an autonomous vehicle, in which case the vehicle 100 may omit the steering wheel and the steering column to steer the vehicle 100. Rather, the vehicle 100 may be operated by an autonomy computing system (not shown in FIG. 1) of the vehicle 100 based on data collected by a sensor network (not shown in FIG. 1) including one or more sensors. The vehicle 100 may be an ego vehicle referenced herein.

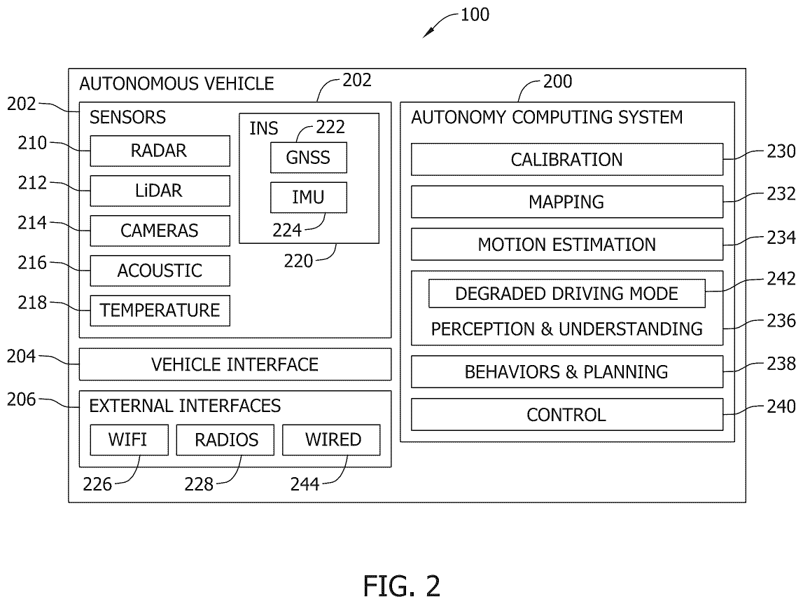

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, and navigation sensors. Navigation sensors, as described herein, may be one or more inertial navigation system (INS) sensors (or systems) 220, one or more global navigation satellite system (GNSS) sensors 222, or one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers or other objects in the environment surrounding autonomous vehicle 100. In some embodiments, the image data generated by cameras 214 may be sent to autonomy computing system 200 or other aspects of autonomous vehicle 100 or mission control (a hub) or both.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment. Additionally, or alternatively, GNSS receiver 222 may be configured to receive RTK and GNSS position information from satellite-based systems.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5G, Bluetooth, etc.). By way of an example, the radios 228 may also include radios or other communication devices for V2X communication.

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and a degraded driving mode module 242. The degraded driving mode 242, for example, may be embodied within another module, such as perception and understanding module 236, behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

The degraded driving module 242 performs AV2AV pairing with another autonomous vehicle, or communicates with other vehicles, pedestrian, or infrastructure using V2V or V2X communication to receive data or information for driving in the degraded mode or performing an MRM, as described herein.

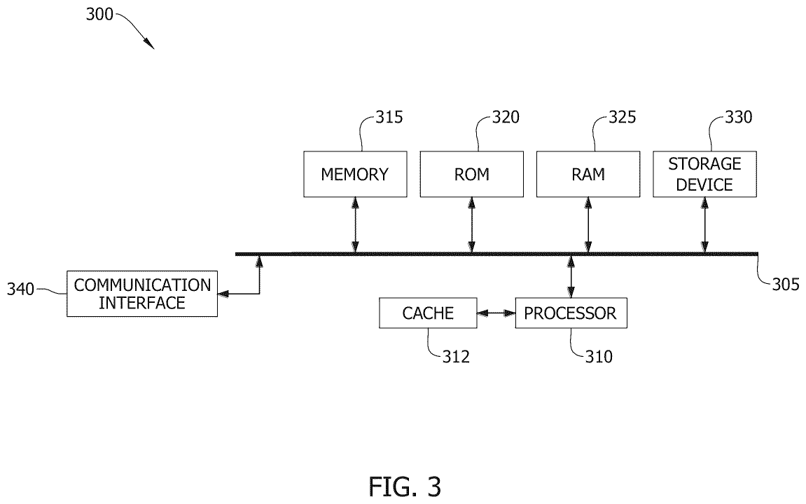

FIG. 3 illustrates an example computing system 300 that can implement various techniques, processes, functions, or methods described herein. Computing system 300 may be embodied within, for example, autonomous vehicle 100 shown in FIG. 1, such as autonomy computing system 200 shown in FIG. 2. The components of computing system 300 are shown in electrical communication with each other using a connection 305, such as a bus. The example computing system 300 includes a processing unit (CPU or processor) 310 and a computing device connection 305 that couples various computing device components, including computing device memory 315, such as a read only memory (ROM) 320 and a random-access memory (RAM) 325, to processor 310.

The processor 310 may be communicatively coupled with a communication interface 340 to communicate with external entities such as, mission control, one or more other vehicles using V2V communication, or with one or more vehicles, pedestrians, or infrastructure using V2X communication. Accordingly, the communication interface 340 may include one or more of a radio interface, an electronic sign board mounted on autonomous vehicle 100, a public address system or a loudspeaker positioned at autonomous vehicle 100. The radio interface may be configured for at least one of: (i) a vehicle-to-vehicle communication technique, (ii) citizens band radio frequencies; (iii) a Bluetooth signal; (iv) communication protocol according to 3GPP standard; and (v) a short message service (SMS) technology.

Computing system 300 can include a cache 312 of high-speed memory connected directly with, in close proximity to, or integrated as part of processor 310. Computing system 300 can copy data from memory 315 and/or storage device 330 to cache 312 for quick access by processor 310. In this way, cache 312 can provide a performance boost that avoids processor 310 delays while waiting for data. These and other modules can control or be configured to control processor 310 to perform various actions. Other computing device memory 315 may be available for use as well. Memory 315 can include multiple different types of memory with different performance characteristics. Processor 310 can include any general-purpose processor, central processing unit (CPU), or graphics processing unit (GPU) in combination with a hardware or software provision configured to control processor 310 and stored in storage device 330, as well as any special-purpose processor where software instructions are incorporated into the processor design. Processor 310 may be a self-contained system, containing multiple cores or processors, a bus, memory controller, cache, etc. A multi-core processor may be symmetric or asymmetric.

Storage device 330 is a non-volatile memory and can be one or more of a hard disk or other types of computer readable media that can store data that are accessible by a computer, such as a magnetic cassette, flash memory card, solid state memory device, digital versatile disk, cartridge, RAM 325, ROM 320, or hybrids thereof. Memory 315 or storage device 330 can include software, code, firmware, etc., for controlling processor 310. Other hardware or software modules are contemplated. Memory 315 and storage device 330 are connected to computing device connection 305. In one aspect, a hardware module that performs a particular function can include the software component stored in a computer-readable medium in connection with the necessary hardware components, such as processor 310, computing device connection 305, and so forth, to carry out the function. In the example embodiment, processor 310 may be programmed by encoding an operation or function using one or more executable instructions and providing the executable instructions in memory 315 or storage device 330.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

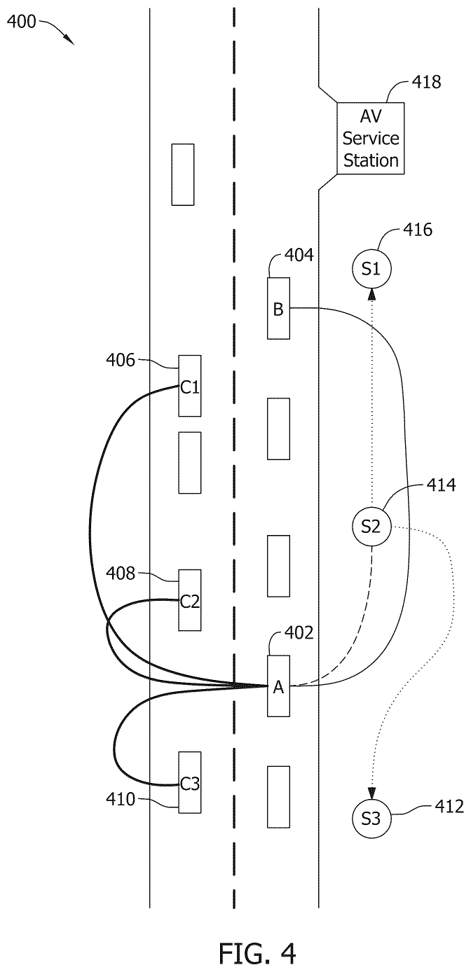

FIG. 4 is an example illustration 400 of a setup of a degraded autonomous vehicle (or an autonomous vehicle) 402 for safe operating in a degraded driving mode or performing a minimal risk maneuver (MRM). The autonomous vehicle 402 may detect that at least one perception sensor (for example, cameras 214, RADAR sensors 210, or LiDAR sensors 212) is malfunctioning or reporting failure, or perception sensor data is showing an obstruction (e.g., a permanent obstruction), the autonomous vehicle 402 may enter into a degraded operation mode (or degraded mode) or determine to perform an MRM. The degraded autonomous vehicle 402 may be in proximity of another autonomous vehicle 404 that is, for example, driving in the same direction as the degraded autonomous vehicle 402. By way of an example, when the degraded autonomous vehicle 402 entered into the degraded operation mode or determined to perform an MRM, vehicle 406, 408, and 410, all belonging to the same feet may also be driving in proximity of the degraded autonomous vehicle 402. The vehicles 406, 408, and 410 may also be driving in the same direction as the degraded autonomous vehicle 402. The vehicles 406, 408, and 410 may be vehicles of the same fleet, and, therefore, may be communicating with each other using V2V communication techniques. The degraded autonomous vehicle 402 may also be in proximity of infrastructure base stations 412, 414, and 416. The infrastructure base stations 412, 414, and 416 may be associated, for example, with cellular communication services, and may provide information or data, for example, current location of the particular infrastructure base station, road information, traffic information, road curvature, etc. The infrastructure base stations 412, 414, and 416 may be positioned along the road such that an autonomous vehicle (or a vehicle) have a continuous coverage while driving on the road.

The degraded autonomous vehicle 402 may pair with one or more of autonomous vehicle 404, vehicles 406, 408, 410, and infrastructure base stations 412, 414, 416 using V2V or V2X communication. Alternatively, the degraded autonomous vehicle 402 may be paired via mission control. The degraded autonomous vehicle 402 may exchange with the paired vehicle (or infrastructure) information including an identification code of the degraded autonomous vehicle 402, a current location of the degraded autonomous vehicle 402, and a fault code. The fault code may identify what sensor or processor fault caused the autonomous vehicle 402 to become the degraded autonomous vehicle 402. Additionally, or alternatively, the degraded autonomous vehicle 402 may exchange with the paired vehicle (or infrastructure) information further including kinematic information of the degraded autonomous vehicle 402, route information 402, and/or description of the fault. As described herein, the degraded autonomous vehicle 402 may pair with other autonomous vehicles in a good condition based upon their current location information.

Upon pairing, one or more paired vehicles in a good condition may enter into an assist mode to assist the degraded autonomous vehicle 402, for example, by driving ahead of the degraded autonomous vehicle 402 like a virtual towing, changing its current route to be same as the route of the degraded autonomous vehicle 402, or by leading the degraded autonomous vehicle to a nearest service hub 418 to get the degraded autonomous vehicle 402 get fixed or repaired. Upon pairing, one or more paired vehicles in a good condition may assist the degraded autonomous vehicle 402, for example, by transmitting their perception data along with their location data so that the degraded autonomous vehicle can be aware of its environment (e.g., road curvature, any non-moving objects on the road, road signs, etc.).

In one example, when none of vehicles 404, 406, 408, and 410 are in proximity of the degraded autonomous vehicle 402, the degraded autonomous vehicle 402 may communicate to infrastructure in close proximity to it and provide or communication information including an identification code of the degraded autonomous vehicle 402, a current location of the degraded autonomous vehicle 402, and a fault code. The fault code may identify what sensor or processor fault caused the autonomous vehicle 402 to become the degraded autonomous vehicle 402. Additionally, or alternatively, the degraded autonomous vehicle 402 may provide or communicate information further including kinematic information of the degraded autonomous vehicle 402, route information 402, and/or description of the fault. As described herein, the infrastructure base stations 412, 414, and 416 are communicatively coupled and act as repeaters to further communicate the received information with vehicles that are connected or paired with other infrastructure. Upon receiving repeated information, the autonomous vehicle may update its course so that it can assist the degraded autonomous vehicle 402, as described herein.

Upon pairing, the degraded autonomous vehicle 402 may drive in the same way as the other vehicle in good condition with which it is paired. The degraded autonomous vehicle may receive perception data, kinematics data, or localization data from the other vehicle in good condition so that the degraded autonomous vehicle may drive or follow the other vehicle in good condition. Additionally, or alternatively, the degraded autonomous vehicle 402 may receive data corresponding to a sensor that is similarly positioned on the other vehicle in good condition that is paired with the degraded autonomous vehicle 402 to assist it to perform an MRM to the nearest service hub 418.

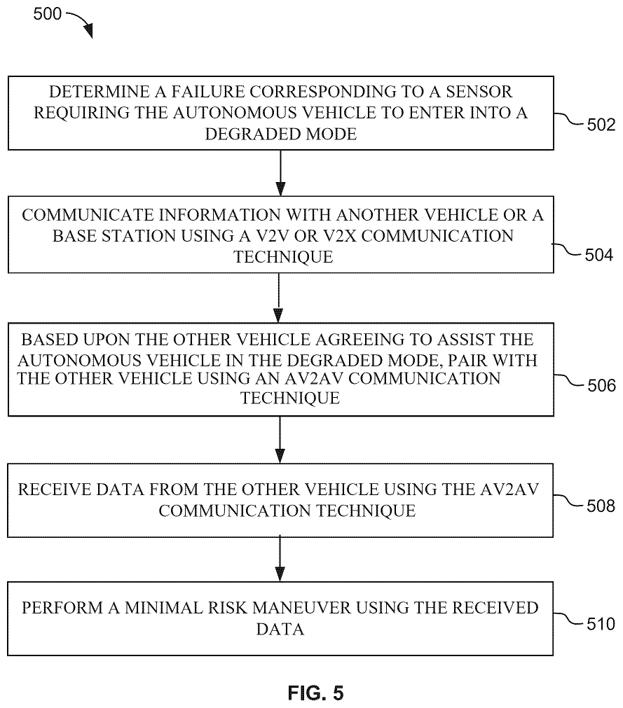

FIG. 5 is a flow diagram 500 of an embodiment method of safe operating in a degraded driving mode or performing a minimal risk maneuver (MRM). The method operations may be performed by the degraded driving mode module 242 (shown in FIG. 2) or a processor 310 (shown in FIG. 3). The method operations include determining 502 a failure corresponding to a sensor requiring the autonomous vehicle to enter into a degraded mode, and communicating 504 information with another vehicle or a base station using a vehicle-to-vehicle (V2V) or vehicle-to-everything (V2X) communication technique. Further, the autonomous vehicle in the degraded mode may communicate with the base station, for example, using V2X communication technique, to search for assistance. As described herein, the failure may correspond to a perception sensor failure, a localization sensor failure, or failure related to any other sensor. Information communicated with the other vehicle or the base station using V2V or V2X communication technique may include one or more of: an identification code of the autonomous vehicle, a current location of the autonomous vehicle, a fault code, kinematic information of the autonomous vehicle, route information, or description of a fault in the sensor.

The method operations include pairing 506 with the other vehicle based upon the other vehicle agreeing to assist the autonomous vehicle in the degraded mode. Pairing 506 with the other vehicle may be performed using an AV2AV communication technique. The method operations include receiving 508 data from the other vehicle using AV2AV communication technique, and performing 510 a minimal risk maneuver using the received data, as described herein. Data received 508 from the other vehicle may include one or more of perception data, localization data, and kinematic data of the other vehicle.

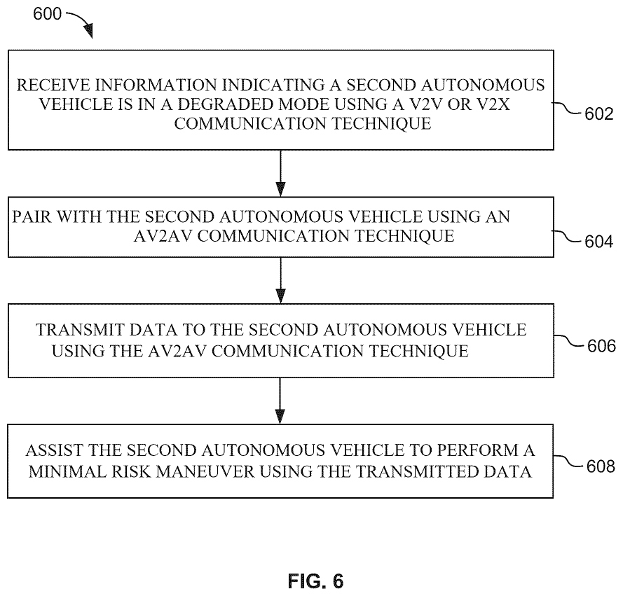

FIG. 6 is a flow diagram 600 of an embodiment method of assisting an autonomous vehicle in a degraded driving mode to perform a minimal risk maneuver (MRM). The method operations may be performed by the degraded driving mode module 242 (shown in FIG. 2) or a processor 310 (shown in FIG. 3). The method operations include receiving 602 information indicating a second autonomous vehicle is in a degraded mode. The information may be received using a vehicle-to-vehicle (V2V) or vehicle-to-everything (V2X) communication technique. The information may be received from the second autonomous vehicle or a base station communicatively coupled with the autonomous vehicle. A failure corresponding to a perception sensor, a localization sensor, or another sensor in the second autonomous vehicle is identified using the received information. Additionally, details such as one or more of an identification code, a current location, a fault code, kinematic information, route information, or a description of a fault in the sensor, of the second autonomous vehicle may also be identified based upon the received 602 information.

The method operations include pairing 604 with the second autonomous vehicle using an autonomous vehicle-to-autonomous vehicle (AV2AV) communication technique, transmitting 606 data to the second autonomous vehicle using the AV2AV communication technique, and assisting 608 the second autonomous vehicle to perform a minimal risk maneuver using the transmitted 606 data. Data transmitted 606 to the second autonomous vehicle may include one or more of perception data, localization data, and kinematic data of the autonomous vehicle. Alternatively, data transmitted 606 to the second autonomous vehicle may be limited to one or more of perception data, localization data, and kinematic data of the autonomous vehicle corresponding to an area of interest corresponding to, or associated with, a sensor that caused the second autonomous vehicle to enter into the degraded mode.

An example technical effect of the methods, systems, and apparatus described herein includes at least providing a safer way for an autonomous vehicle to operate on a public road by reducing the amount of uncertainty when the autonomous vehicle enters into a degraded mode by leveraging infrastructure base stations to find an optimal functioning autonomous vehicle and enabling the optimal functioning autonomous vehicle to assist the degraded autonomous vehicle. Upon pairing of the degraded autonomous vehicle with the functioning autonomous vehicle, information such as position information, trajectory information, and kinematic information may be exchanged between the degraded autonomous vehicle and the functioning autonomous vehicle.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a program, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random-access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein, including the implementation or utilization of components of the systems or steps independently and separately from other described components or steps. Therefore, it is manifestly intended that embodiments described herein be limited only by the claims.

What is claimed is:

1. An autonomous vehicle comprising:
at least one memory configured to store machine executable instructions; and
at least one processor coupled to the at least one memory and configured to execute the machine executable instructions to:
receive information indicating a second autonomous vehicle is in a degraded mode using a vehicle-to-vehicle (V2V) or vehicle-to-everything (V2X) communication technique;
pair with the second autonomous vehicle using an autonomous vehicle-to-autonomous vehicle (AV2AV) communication technique;
transmit data to the second autonomous vehicle using the AV2AV communication technique; and
assist the second autonomous vehicle to perform a minimal risk maneuver using the transmitted data.

2. The autonomous vehicle of claim 1, wherein the at least one processor is further configured, upon executing the machine executable instructions, to: identify a failure corresponding to a perception sensor in the second autonomous vehicle using the information.

3. The autonomous vehicle of claim 1, wherein the information is received from the second autonomous vehicle or a base station communicatively coupled with the autonomous vehicle.

4. The autonomous vehicle of claim 1, wherein the at least one processor is further configured, upon executing the machine executable instructions, to: identify details corresponding to the second autonomous vehicle based upon the information including one or more of: an identification code, a current location, a fault code, kinematic information, route information, or a description of a fault in the sensor, of the second autonomous vehicle.

5. The autonomous vehicle of claim 1, wherein the at least one processor is further configured, upon executing the machine executable instructions, to: transmit perception data, localization data, and kinematic data of the autonomous vehicle to the second autonomous vehicle.

6. The autonomous vehicle of claim 1, wherein the at least one processor is further configured, upon executing the machine executable instructions, to: transmit perception data, localization data, kinematic data of the autonomous vehicle corresponding to an area of interest corresponding to a sensor that caused the second autonomous vehicle to enter into the degraded mode.

7. The autonomous vehicle of claim 1, wherein the at least one processor is further configured, upon executing the machine executable instructions, to: identify, based upon the information, a failure corresponding to a localization sensor in the second autonomous vehicle.

8. A computer-implemented method comprising:
receiving, by a processor of a first autonomous vehicle, information indicating a second autonomous vehicle is in a degraded mode using a vehicle-to-vehicle (V2V) or vehicle-to-everything (V2X) communication technique;
pairing, by the processor, with the second autonomous vehicle using an autonomous vehicle-to-autonomous vehicle (AV2AV) communication technique;
transmitting, by the processor, data to the second autonomous vehicle using the AV2AV communication technique; and
assisting, by the processor, the second autonomous vehicle to perform a minimal risk maneuver using the transmitted data.

9. The computer-implemented method of claim 8, further comprising identifying, by the processor, a failure corresponding to a perception sensor in the second autonomous vehicle using the information.

10. The computer-implemented method of claim 8, wherein the information is received from the second autonomous vehicle or a base station communicatively coupled with the autonomous vehicle.

11. The computer-implemented method of claim 8, further comprising identifying, by the processor, details corresponding to the second autonomous vehicle based upon the information including one or more of: an identification code, a current location, a fault code, kinematic information, route information, or a description of a fault in the sensor, of the second autonomous vehicle.

12. The computer-implemented method of claim 8, further comprising transmitting, by the processor, perception data, localization data, and kinematic data of the autonomous vehicle to the second autonomous vehicle.

13. The computer-implemented method of claim 8, further comprising transmitting, by the processor, perception data, localization data, kinematic data of the autonomous vehicle corresponding to an area of interest corresponding to a sensor that caused the second autonomous vehicle to enter into the degraded mode.

14. The computer-implemented method of claim 8, further comprising identifying, by the processor, based upon the information, a failure corresponding to a localization sensor in the second autonomous vehicle.

15. A non-transitory computer-readable media (CRM) comprising machine executable instructions stored thereon, which, when executed by at least one processor of a computing system of an autonomous vehicle, cause the computing system to perform operations comprising:
receiving information indicating a second autonomous vehicle is in a degraded mode using a vehicle-to-vehicle (V2V) or vehicle-to-everything (V2X) communication technique;
pairing with the second autonomous vehicle using an autonomous vehicle-to-autonomous vehicle (AV2AV) communication technique;
transmitting data to the second autonomous vehicle using the AV2AV communication technique; and
assisting the second autonomous vehicle to perform a minimal risk maneuver using the transmitted data.

16. The non-transitory CRM of claim 15, wherein the operations further comprising identifying a failure corresponding to a perception sensor or a localization sensor in the second autonomous vehicle using the information.

17. The non-transitory CRM of claim 15, wherein the information is received from the second autonomous vehicle or a base station communicatively coupled with the autonomous vehicle.

18. The non-transitory CRM of claim 15, wherein the operations further comprising identifying details corresponding to the second autonomous vehicle based upon the information including one or more of: an identification code, a current location, a fault code, kinematic information, route information, or a description of a fault in the sensor, of the second autonomous vehicle.

19. The non-transitory CRM of claim 15, wherein the operations further comprising transmitting perception data, localization data, and kinematic data of the autonomous vehicle to the second autonomous vehicle.

20. The non-transitory CRM of claim 15, wherein the operations further comprising transmitting perception data, localization data, kinematic data of the autonomous vehicle corresponding to an area of interest corresponding to a sensor that caused the second autonomous vehicle to enter into the degraded mode.
